(19) United States
(12) Patent Application Publication
(10) Pub. No.: US 2015/0243178 A1
(43) Pub. Date: Aug. 27, 2015

(54) CONTENT DRIVEN ASYNCHRONOUS EDUCATION

(71) Applicant: 2U, Inc., Landover, MD (US)

(72) Inventor: Ian Van Tuyl, New York, NY (US)

(21) Appl. No.: 14/190,426

(22) Filed: Feb. 26, 2014

(51) Int. Cl. G09B 7/00; G09B 5/02

(52) U.S. Cl. CPC G09B 7/00; G09B 5/02

(57) ABSTRACT

A system for asynchronous education content delivery is disclosed. A data store comprises education content associated with a course of learning and sequence data specifying an order for presentation of the content. Education content comprises video recordings of lectures, questions, and model responses. The system receives students' requests for data, queries the database in order to identify the appropriate content, and transmits the content. The system may require that a student provide input in response to a recorded prompt in order to proceed with a planned course of study. The student's inputs are made available to other students and teachers for further review and critique.

### BACKGROUND

Traditionally, teaching has taken place in a setting where both teachers and students gather in the same place at the same time. For example, a grammar school teacher may discuss topics with a classroom full of students seated before him. Similarly, a college professor may lecture to her students congregated in a lecture hall.

In these traditional teaching settings, students learn not only from the lectured materials but also from the interactions between the teacher and fellow students. The teacher or professor poses questions to the class and students in the class volunteer responses. The process is interactive with the teacher or professor responding to the students' answers or responses. Frequently, the teacher or professor responds to a student's input with an explanation or comment followed by further questions for the students. The teacher and students engage in a dialogue whereby students learn through critical thinking about the issues raised during the interchange. Such a process is sometimes referred to as the Socratic teaching method. Not only do the students in the class learn from the teacher's comments and questions, but also from the responses by their fellow classmates. Students in the class remain engaged in the conversation knowing that they may be called upon to take part in the dialogue.

### SUMMARY

Applicants have developed computer-implemented systems and methods for asynchronous interactive teaching. The disclosed systems and methods replicate the interactive classroom learning experience, but allow for the experience to take place asynchronously and at the convenience of the students. Students are presented with recorded lectures, related questions, and model student responses to questions, all at the convenience of the student. Students may be required to provide input such as responses to questions in order to continue with a course of learning. Student inputs may be made available for consideration by others including teachers and other students.

In an exemplary embodiment, education content, such as, for example, recordings of educational subject matter are stored in a data store. The recordings may contain, for example, video recordings of portions of lectures presented by a teacher or professor. Recordings of questions relevant to the recorded lectured materials are also stored in a data store. For example, questions that the teacher or professor would normally present to students if the lecture were given in a classroom may be recorded and stored in the data store. In addition, recorded responses to the recorded questions are stored in the data store. For example, responses by students or former students to the various questions are reviewed and placed in the data store for review by current students. The recorded responses may be model responses recorded at the direction of the course instructor.

In an example embodiment, the data store may still further comprise sequence data that specifies relationships between the recorded lecture content, recorded question content, and recorded answers. For example, the sequence data may specify that a particular recorded question be presented to a user of the system after a particular recorded lecture segment. Similarly, the sequence data may specify that a particular recorded response be presented to a user of the system after a particular recorded question is presented. The sequence data may still further specify that input is expected from a user of the system after a particular content segment is presented to the user. For example, the sequence data may specify that the student is required to upload a video recording response to a presented question.

In an example embodiment, the data store may further comprise student data for student users of the system. For example, the student data may comprise administrative data regarding the student such as biographical information and registration data. The student data may further comprise data regarding the particular student's progress in a course of study. For example, the student data may comprise data indicating which portions of a course the particular student has downloaded, which portions of a course the particular student has actually reviewed, and which requests for user input or questions the particular student has responded to. The inputs or responses from the students are likewise stored in the data store.

In an example embodiment, an education content server is communicatively coupled with the data store. The education content server is likewise accessible, perhaps via a network such as the Internet, to client devices. The education content server receives requests for education content from the client devices and queries the sequence data and education data to determine the appropriate content to provide to the requesting student. The education content server is also adapted to receive inputs from students, including video and audio recordings, which are then stored in the data store and thereafter made available to other students and teachers.

According to one example scenario, the education content server may receive a request from a student via the network for a recorded lecture segment. The requested lecture segment may be a segment in a successive series of lecture segments in a planned course of study as specified by the sequence data. In response to the request, the education content server queries the data store for the requested content. In an example scenario, the education content server may query the sequence data in order to determine the content that should be provided to the student in response to the request. In another example scenario, the request may designate the particular education content that is requested. The education content server retrieves the appropriate education content, which may be, for example a video recording of a portion of a lecture.

The education content server then transmits the retrieved education content to the student that requested the content. In an example scenario, the content is transmitted over a network such as the Internet to a client device operated by the student. The education content server updates the student data to reflect that the data was communicated to the particular student.

The education content server may next determine that the student has completed reviewing the transmitted content. For example, the education content server may receive a request via the network from the student for the next content designated in the course of study. The request may be for a specific item or may specify only that the next item in the curriculum be provided to the student. The education content server identifies the particular content, which may involve querying the sequence data, and retrieves the content from the data store. In an example scenario, the content retrieved from the data store is a recorded request for student input. For example, the retrieved content may be a video recording of a question from a teacher. The recorded request for input is transmitted to the student. The education content server updates the student data to reflect that the data was communicated to the particular student.

The education content server may then determine that the student has completed reviewing the recorded request for input. For example, the education content server may receive an automated response when the student completes reviewing the previously transmitted content. In an alternative scenario, the education content server may receive a request via the network from the student for the next content designated in the course of study. The request may be for a specific item, such as a recorded response to the previously transmitted question, or may specify only that the next item in the curriculum be provided to the student. The education content server identifies the particular content, which may involve querying the sequence data, and retrieves the content from the data store. In an example scenario, the content retrieved from the data store is a recorded response to a previously transmitted request for input. For example, the retrieved recorded response may be a response to the question prepared by another student or model response created in connection with the curriculum and intended to be viewed as a part of the course of study. The recorded response is transmitted to the student. The education content server updates the student data to reflect that the data was communicated to the particular student.

The education content server may next determine that the student has completed reviewing the recorded response to the previously transmitted request for input. For example, the education content server may receive a request via the network from the student for the next content designated in the course of study. The request may be for a specific item or may specify only that the next item in the curriculum be provided to the student. The education content server identifies the particular content, which may involve querying the sequence data, and retrieves the content from the data store. In an example scenario, the content retrieved from the data store is another recorded request for input from a student. For example, the retrieved content may be a video of a question previously recorded by the teacher and which, according to the data in the sequence data, is appropriate for the particular student to review during his/her course of study. The recorded request for input is transmitted to the student. The education content server updates the student data to reflect that the data was communicated to the particular student.

In an example scenario, the education content server monitors for an input in response to a request for student input. For example, the education content server monitors for receipt of a video recording of a response from the student to the question that was presented. In an example embodiment, the education content server may deny further requests from the particular student until after an input is received from the student.

Continuing with an example scenario, upon receipt of a response from the student, the education content server updates the student data for the particular student to reflect that the student has made his/her submission. The education content server stores the actual submission from the student as well.

The education content server may then make the submission from the student available for others to review. For example, in one potential scenario, the submission is made available to a teacher or supervisor for review. In another potential scenario, the submission may be made available to other students that are following the same or a similar course of study.

The education content server may continue to receive further requests from the particular student in order to complete a particular course of study. For example, requests may be received for additional lecture materials, requests for input, previously recorded responses to input, etc.

According to an aspect of the disclosed embodiments, the education content service may present education content based, at least in part, on a student's responses to questions posed during the course curriculum. As noted above, sequence data may be used to define the sequence for presenting education content and corresponding requests for student input. Often the sequence of presentation of content and requests for student input is linear, and the linear sequence applies to all students. However, in other instances, the presentation of education content is not entirely linear, but rather, depends, at least in part, on a student's prior review of education content and responses to requests for input. For example, after presenting education content to a student and receiving the student's response to a request for response, the system may evaluate the student's response. Depending upon the evaluation of the response, the student may selectively be presented with different content than a student that responded differently. For example, if the system determines that the student's response is correct, the system refers to sequence data in order to identify a next item of education content that should be presented. If the student responded correctly, he or she may be ready to proceed with education content that addresses a new issue. However, where the student responded incorrectly, he or she might benefit from additional educational content regarding a particular point that the instructor is attempting to communicate. In an alternative scenario, the system may have presented a request for student input that does not have a correct or incorrect response, but rather, may be responded to with any number of acceptable inputs. For example, the system may have requested that the student select one of several different alternatives, any one of which is acceptable but which results in a different path or branch through a course of study. For example, in an example scenario wherein the course of study relates to American history, the system may request that the student select from a list of historical figures (e.g., Thomas Paine, Benjamin Franklin, John Adams, and Patrick Henry). In response to the student's selection, the system queries its sequence database to identify content corresponding to the particular historical figure that was selected. In scenarios wherein the sequence data allows a user to select one of several alternatives, the sequence data may further specify that a student is obligated to subsequently select the other items in the list as part of the course of study. For example, in the scenario wherein the student must select from a list of historical figures, at the conclusion of the content for a first selected historical figure, the student again may be required to select one of the remaining historical figures and proceed through the corresponding education content for that particular figure.

According to another aspect of the disclosed embodiments, the education content service provides automated processes for facilitating evaluation of teaching content. For example, the service may facilitate determining whether students are having difficulty understanding a particular concept or teaching point. The service automatically evaluates responses provided by students to questions posed during their course of study. For example, after recording a student's response to a particular request for student response, the service may evaluate whether or not the student's response is acceptable. In an example scenario, the question posed may have only one correct answer, and all responses from students may be evaluated relative to the known correct answer. The system aggregates the number of incorrect responses and once the aggregate exceeds a threshold, the system notifies an appropriate person such as the course instructor. The course instructor may then consider what remedial action should be taken to address the students' less than optimal responses to the particular question. For example, the instructor may review the question herself to determine whether the format of the question is confusing. Alternatively, the instructor may consider whether the teaching materials and/or teaching process are in need of improvement.

According another aspect of the disclosed embodiments, the education content service allows for an instructor or professor to control the distribution of any feedback that the instructor provides. For example, an instructor or professor may review a student's response to a particular question and provide feedback regarding the student response. The instructor may also specify who may access the instructor's feedback. For example, the instructor may specify that only the student who prepared the response may access the feedback. In another example scenario, the instructor may specify that the student and the teaching assistant may access the feedback. In still another scenario, the instructor may specify that all students in the class may access the instructor's feedback. Accordingly, when a student accesses another student's response, the student may or may not be able to access the instructor's comments regarding the response depending upon the limitations imposed by the instructor.

According to yet another aspect of the disclosed embodiments, the education content service allows students to provide recommendation feedback regarding responses prepared by other students. For example, a student who has requested and reviewed another student's response to a question may recommend the particular response. In an example scenario, the recommendation may comprise a ranking of the response relative to other responses. In another scenario, the student may enter a vote for the particular response. The vote may be an indication that the student believes the response to be the best response. The service maintains aggregate recommendation information and updates the information as new recommendation information received. For example, an aggregate value may be maintained identifying the number of recommendations that have been received for a particular response. In another scenario, an aggregate may record the total number of students that have voted for a particular response as being the best. The recommendation information may be presented to subsequent students who may use the recommendation data in determining which responses to review.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The foregoing summary and the following additional description of the illustrative embodiments may be better understood when read in conjunction with the appended drawings. It is understood that potential embodiments of the disclosed systems and methods are not limited to those depicted.

FIG. 1 is a network diagram of an illustrative interactive asynchronous education system.

FIG. 2 is a diagram depicting functional components of an illustrative interactive asynchronous education system.

FIG. 3 is a flow diagram of a process for interactive asynchronous education.

FIG. 4 is a flow diagram of a process for response driven presentation of education content.

FIG. 5 is a flow diagram of a process for automated evaluation of teaching content.

FIG. 6 is a flow diagram of a process for selective access to instructor comments.

FIG. 7 is a flow diagram of a process for student recommendation of student responses.

FIG. 8 is a block diagram of an exemplary computing environment that may be used to implement the systems and methods described herein.

### DETAILED DESCRIPTION OF ILLUSTRATIVE EMBODIMENTS

Example Computing Arrangement

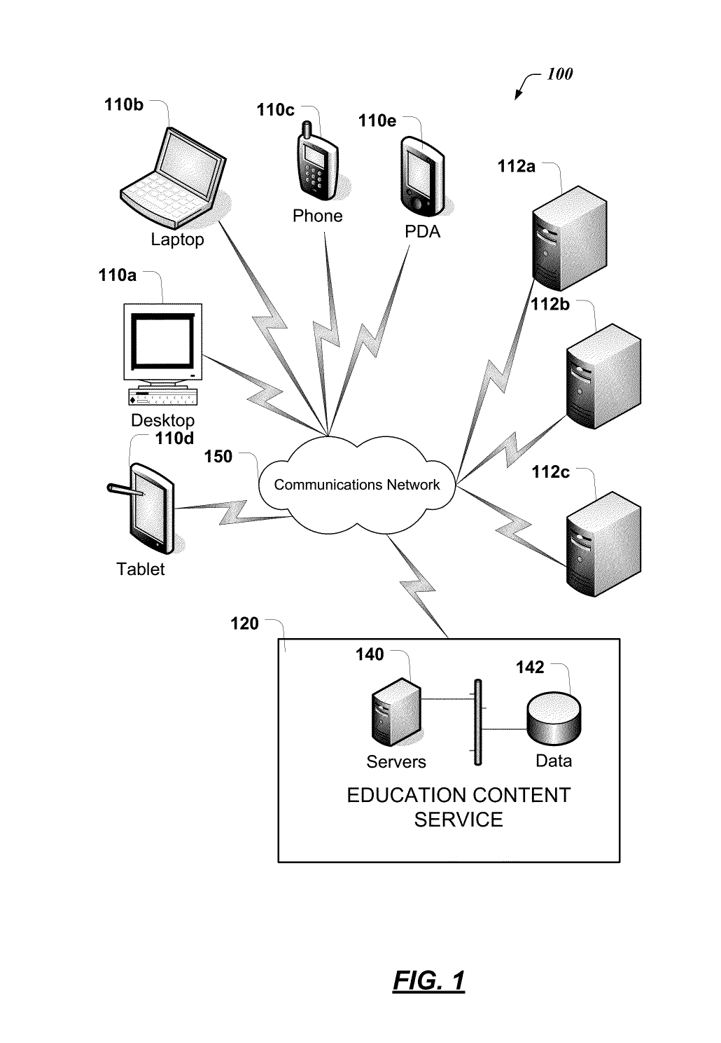

FIG. 1 illustrates an exemplary computing network 100 suitable for interactive asynchronous education. Interactive education content service 120 is adapted to receive and maintain educational content such as recorded lectures and recorded requests for inputs, i.e., recorded questions. Education content service 120 is further adapted to process requests for educational content, determine the appropriate content for transmission according to a course of study, and to transmit the appropriate content.

In an example embodiment, service 120 comprises servers 140 which are communicatively coupled with data stores 142. Servers 140 may comprise any computing device that is adapted to perform the functionality as described herein including, for example, communicating with external data sources 112 to receive education content such as recordings of lectures and questions, store the data, and to query the data stores in order to identify the correct educational content to be transmitted to a particular student as described herein. Servers 140 are communicatively coupled, perhaps using a computing network, with data stores 142. Data stores 142 maintain any data that may be needed to support the functionality described herein. For example, data stores 142 may be employed to store education content such as recorded lecture segments, recorded questions that are intended to be interspersed with the lectured segments, recorded responses to questions (some which may be model responses), and sequence data that identifies courses of study and the order that lecture segments, questions, and responses are to be presented during a course of study. Data stores 142 may comprise any data storage technology that may be adapted to provide the functionality described herein. Any number of servers 140 and data stores 142 may be used to provide education content services as described herein.

Service 120 is adapted to receive education content data from sources 112a-c via communications network 150. Sources 112a-c may be any source from which education content may be received including, for example, computing machines associated with education providers such as universities, high schools, or other entities that create education content. The format of the data received may be any type that is suitable for use as described herein. For example, video recordings of lectures, questions, and approved responses may be received in .wav format or any other suitable format.

Users may employ computing devices 110a-e to interface with service 120 via communications network 150. Computing devices 110a-e may be used to interface with service 120 in order to, for example, request education content such as lectures, teacher questions, and previously recorded answers to questions. Further devices 110a-e may be used to input data such as responses to questions transmitted by service 120 to students. Computing devices 110a-e may be any type of device that is operable to communicate with service 120. For example, computing devices 110a-e may be desktop computers, laptop computers, wireless phones, personal digital assistants, tablet computers, media players, etc. While only five devices are illustrated in FIG. 1, it is understood that service 120 may be accessed via any number of computing devices 110a-e. Computing devices 110a-e may employ any technology that is suitable to interface with service 120 including, for example, Web browser and Internet technology.

Service 120 is accessible via communications network 150. Communications network 150 may be any type of network that is suitable for providing communications between computing devices 110a-e and service 120. Moreover, communications network 150 may comprise a combination of discrete networks which may use different technologies. For example, communications network 150 may comprise local area networks (LANs), wide area networks (WAN's), cellular networks, or combinations thereof. Communications network 150 may comprise wireless, wireline, or combination thereof. In an exemplary embodiment, communications network 150 comprises the Internet and may additionally comprise any networks adapted to communicate with the Internet.

Computing arrangement 100 may employ a host of network topologies such as client/server, peer-to-peer, or hybrid architectures. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computing device, such as one of devices 110a-e that accesses shared network resources provided by another computer (i.e., a server). A server, such as device 140, is typically a remote computer system accessible over a remote network such as the Internet. The client process may be active in a first computer system, and the server process may be active in a second computer system, communicating with one another over a communications medium and allowing multiple clients to take advantage of the information-gathering capabilities of the server.

Clients and servers communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Uniform Resource Locator (URL) or an Internet Protocol (IP) address is used to identify the server or client computers to each other. Communication among computing devices is provided over a communications medium. In particular, the client and server may be coupled to one another via TCP/IP connections for high-capacity communication.

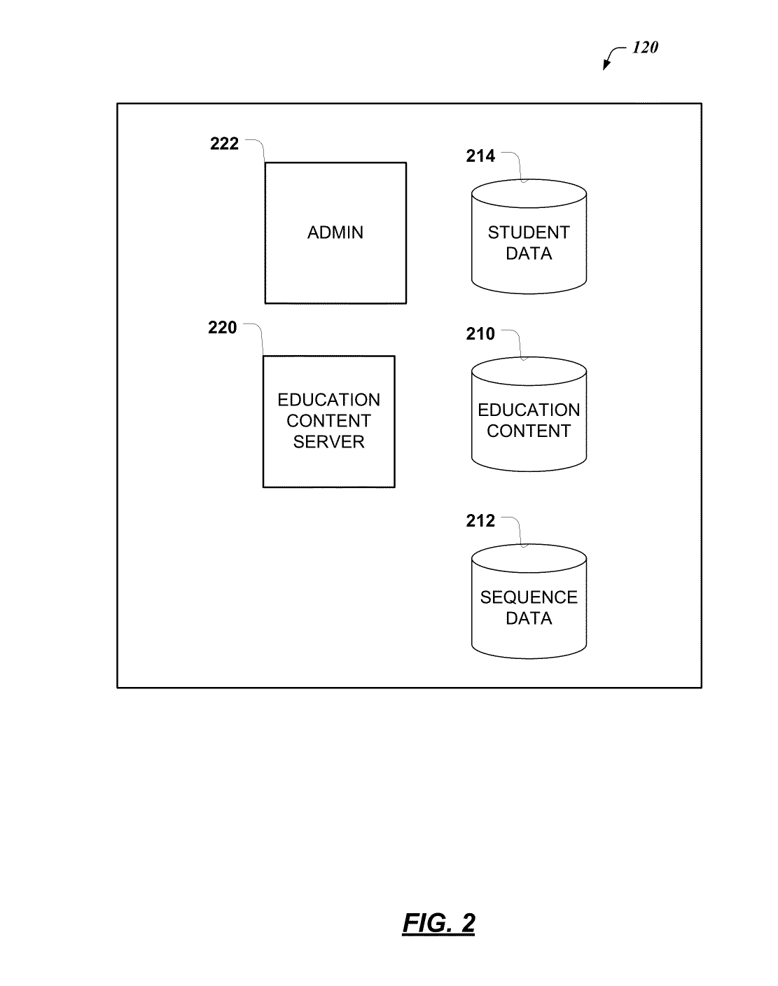

FIG. 2 depicts a block diagram illustrating example logical components of an illustrative service 120 for providing asynchronous access to education content. In the example embodiment depicted in FIG. 2, education content database 210 represents the functional database operations performed by service 120 in connection with storing, maintaining, and accessing education content data. Education content database 210 comprises any data that may be presented in connection with a class, curriculum, or other course of study. Education content database 210 comprises recorded lectures or lecture segments that may be presented during a course of study. For example, education content database 210 may comprise lecture segments for a high school history class, a college physics class, a law school real property class, a continuing professional education class, or any other type of course of study. Education content database 210 further comprises requests for input or questions that correspond to the lecture content. For example, the database may comprise recorded questions that are typically posed to students taking a particular course of study. The questions may be intended to be interspersed in a particular order with lecture content. Education content database 210 may further comprise recorded responses to questions. For example, the recorded responses may be model responses that have been reviewed and approved for review by students. The recorded responses may be “canned” or model responses that were strategically included so as to teach a particular point. The recorded responses may be actual responses from students in a particular course. The lecture segments, requests for inputs, and responses may be in any format that is suitable for storage, transmission, and display. For example, the data may be formatted as .avx or .wav files or any similar format. The lecture segments, recorded questions, and responses may be as long or as short as determined best for presenting a course. The education content may comprise education content for a plurality of different courses and organizations.

Sequence data database 212 represents the functional database operations performed by service 120 in connection with storing, maintaining, and accessing sequence data. Sequence data comprises data that specifies for courses of study the particular education content, questions, and responses that are to be presented and the sequence that they are to be presented. For example, sequence data may specify for a particular law school class on real property, that a first lecture segment is to be presented, followed by a particular question, followed by a particular model response, etc. The sequence data further specifies the particular locations where student input is required. For example, the sequence data may specify that a particular question is to be presented and, thereafter a student input is required before further content may be made available to the student. The sequence data may comprise data specifying courses of study for a plurality of different courses and organizations.

Student data database 214 represents the functional database operations performed by service 120 in connection with storing, maintaining, and accessing student data. Student data comprises any data relating to particular students that is needed to provide functionality as described herein. In an example, embodiment, student data may comprise administrative data regarding students such as name, address, etc. The student data may further comprise data regarding the courses that the particular student is currently registered to participate in. The student data may still further comprise data regarding the progress that particular students have made in a course. For example, the student data may specify that a student has reviewed particular lectures, questions, and model responses, and or provided particular inputs. The student data may further specify that the student has yet to complete other components of a particular course of study. The student data may further comprise inputs that are provided by the student in connection with a course of study. For example, the student data may comprise the video recordings or text inputs that a student made in connection with taking a course. The students' inputs may be made available to professors for review and grading and may be made available to other students for review, evaluation, and critique.

Education content server 220 acts as an interface to service 120 and provides, with the databases, 210-214 the functionality as described herein. Education content server 220 may comprise functionality for serving data corresponding to a user interface such as, for example, web pages.

Administrative server 222 provides administrative functionality to service 120. In an example embodiment, administrative server 222 provides an interface to add education content such as lectures, questions, and model responses to the database. Administrative server 222 may further provide functionality that allows for teachers to access content such as student responses to recorded requests for input and to enter feedback regarding the student responses. For example, the administrative server 222 may provide functionality that allows a teacher to enter a grade and comments regarding a student's response.

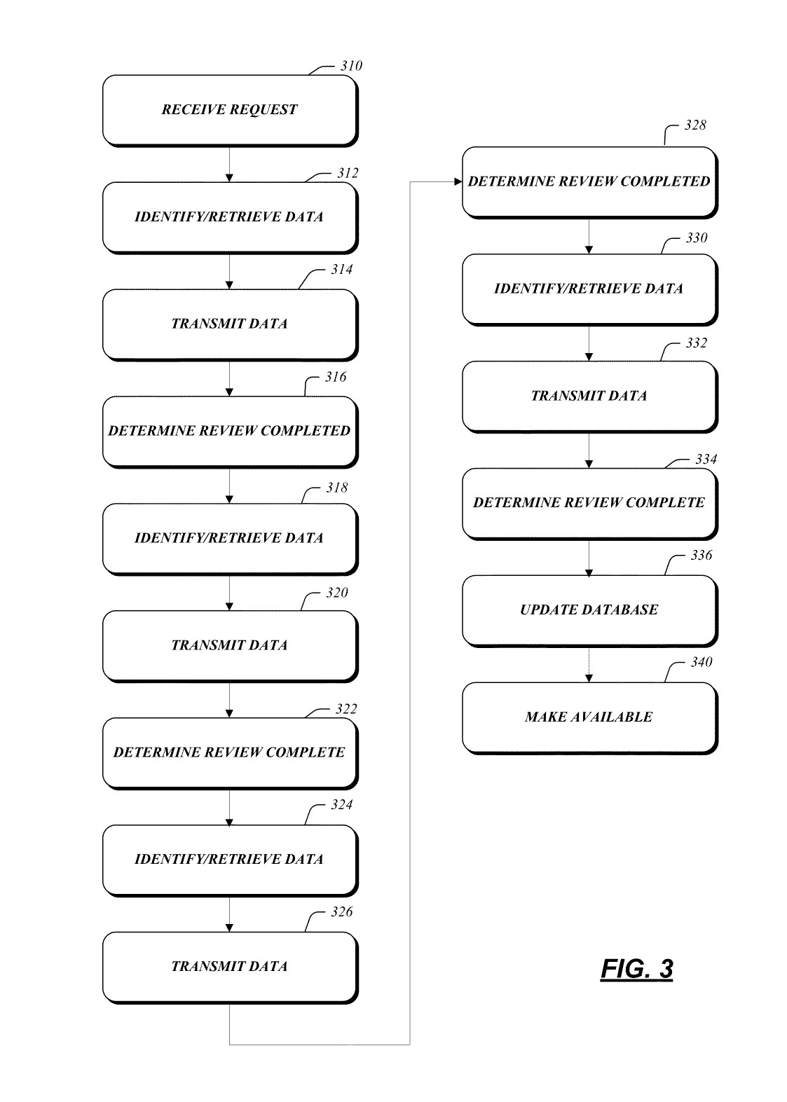

FIG. 3 depicts a flow chart of example processing performed in an interactive education content service 120. As shown, at block 310, education content server 220 receives a request from a student via network 150 for a recorded lecture segment. The request may have originated from any of devices 110. In an example scenario, the student may have previously registered for a particular course of study such as, for example, a college history class or law school class on real property. The request received from the student may be a request for the next lecture segment associated with the particular class.

At block 312, and in response to the request, education content server 220 queries the data store (210-214) for the requested content. In an example scenario, education content server 220 may query sequence data 212 in order to determine the content that should be provided to the student in response to the request. For example, education content server 220 may query sequence database 212 and student database 214 in order to determine the next education content item that should be provided to the student based upon the student's progress in the course of study. In another example scenario, the request received at education content server 220 may designate the particular education content that is requested. After determining which education content is appropriate for the particular student, education content server 220 retrieves the identified education content from education content database 210. The retrieved content may be any that is suitable for use in an education setting and may take any suitable format including text, audio, and/or video. In an example scenario, the retrieved education content may be, for example, a video recording of a portion of a lecture.

At step 314, education content server 220 transmits the retrieved education content to the student that requested the content via network 150. In the scenario wherein the education content is a recorded portion of a lecture, the portion of the recorded lecture is transmitted. Education content server 220 updates student data database 214 to reflect that the data was communicated to the particular student. The transmitted data is received at any one of devices 110 operated by the student.

At step 316, education content server 220 may determine that the student has completed reviewing the transmitted content. For example, education content server 220 may receive an automated response via network 150 when the student completes reviewing the previously transmitted content. In an alternative scenario, education content server 220 may receive a request via network 150 from the student for the next content designated in the course of study. The request may be for a specific item or may specify only that the next item in the curriculum be provided to the student. At step 318, education content server 220 identifies particular content to be provided to the student. The process may involve querying sequence data database 212 and student data 214. For example, in an example scenario, education content server 220 may query student data 214 in order to determine which program the particular student is undertaking and the segment of information that was most recently reviewed by the particular student. Education content server 220 may then query sequence data 212 in order to identify the appropriate segment to be provided to the student given the current progress of the student in the course of study. The identified content is then retrieved from education content database 210. In an example scenario, the content retrieved from the data store is a recorded request for student input or response. The retrieved content may be any suitable for use in an education setting and may take any suitable format including text, audio, and/or video. In an example scenario, the retrieved education content may be, for example, a video recording of a question presented by a teacher or professor.

At step 320, education content server 220 transmits the retrieved request for input to the student via network 150. In the scenario wherein the retrieved request for input is a video of a recording of a question, the video is transmitted. Education content server 220 updates the student data database 214 to reflect that the data was communicated to the particular student. The transmitted data is received at any one of devices 110 operated by the student.

At step 322, education content server 220 may determine that the student has completed reviewing the transmitted request for input. For example, education content server 220 may receive an automated response via network 150 when the student completes reviewing the previously transmitted content. In an alternative scenario, education content server 220 may receive a request via network 150 from the student for the next content designated in the course of study. The request may be for a specific item, such as a recorded response to the previously transmitted question, or may specify only that the next item in the curriculum be provided to the student.

At step 324, education content server 220 identifies the particular content to be provided to the student. The process may involve querying sequence data database 212 and student data 214. For example, in an example scenario, education content server 220 may query student data 214 in order to determine which program the particular student is undertaking and the latest segment of information that was reviewed by the particular student. Education content server 220 may then query sequence data 212 in order to identify the appropriate segment to be provided to the student given the current progress of the student in the course of study. The identified content is then retrieved from education content database 210. In an example scenario, the content retrieved from education content database 210 is a recorded response to a previously transmitted request for student input or response. For example, the retrieved recorded response may be a response to the question prepared by another student or model response created in connection with the curriculum and intended to be viewed as a part of the course of study. The retrieved content may be any suitable for use in an education setting and may take any suitable format including text, audio, and/or video. In an example scenario, the retrieved response may be, for example, a video recording. In still another embodiment the retrieved response may comprise a plurality of responses prepared by several different persons.

At step 326, education content server 220 transmits the retrieved recorded response to the student via network 150. Education content server 220 updates the student data database 214 to reflect that the data was communicated to the particular student. The transmitted data is received at any one of devices 110 operated by the student.

At step 328, education content server 220 may determine that the student has completed reviewing the recorded response to the previously transmitted request for input. For example, education content server 220 may receive an automated response via network 150 when the student completes reviewing the previously transmitted content. In an alternative scenario, education content server 220 may receive a request via network 150 from the student for the next content designated in the course of study. The request may be for a specific item, such as another recorded question that is next in a course of study, or may specify only that the next item in the curriculum be provided to the student.

At step 330, education content server 220 identifies the particular content to be provided to the student. The process may involve querying sequence data database 212 and student data 214. For example, in an example scenario, education content server 220 may query student data 214 in order to determine which program the particular student is undertaking and the latest segment of information that was reviewed by the particular student. Education content server 220 may then query sequence data 212 in order to identify the appropriate segment to be provided to the student given the current progress of the student in the course of study. The identified content is then retrieved from education content database 210. In an example scenario, the content retrieved from education content database 210 is another recorded request for input or response from a student, i.e., another question. For example, the retrieved content may be a video of a question previously recorded by the teacher and which, according to the data in the sequence data, is appropriate for the particular student to review during his/her course of study. In another example scenario, the request for input may be a request that the student provide a critique of the recorded response that the student just recently reviewed.

At step 332, education content server 220 transmits the retrieved recorded request for response to the student via network 150. Education content server 220 updates the student data database 214 to reflect that the data was communicated to the particular student. The transmitted data is received at any one of devices 110 operated by the student.

At step 334, education content server 220 may determine that the student has input a response to the request for input transmitted at step 332. In an example scenario, education content server 220 may be monitoring for student input and receives an input such as, for example, a text input response, an input selection from a provided set of responses, and/or a video recording of a response from the student to the question that was presented in the previously transmitted request for input. In another example scenario, the received input may be a critique of the recently reviewed recorded response. In an example embodiment, education content server 220 may deny or not process further requests from the particular student until after an input is received from the student.

At step 336, upon receipt of a response from the student, education content server 220 updates student data database 214 to reflect that the student has made his/her submission and stores the actual submission. The submission may be any type of data responsive to the request for input that was previously transmitted. For example, the received input may be a video recorded response, an audio recording of a response, a document containing a typed response, or a selection from a system provided list of possible responses.

At step 340, education content server 220 may make the student's submission available for others to review. For example, in one potential scenario, education content server 220 may update education content database 210 to indicate that the submission from the student is available for other students to review and possibly critique. In an example scenario, a student other than the student that entered the input may thereafter access the received response and enter feedback regarding the submission. Education content server 220 may also update education content database 210 to indicate that the received student input is available for review and comment by an instructor. In an example scenario, a teacher or instructor may thereafter access administrative functionality 222 to access the received response and enter feedback regarding the submission. The student, as part of his/her course of study may subsequently retrieve the feedback from either the teacher or other students and, in some embodiments, submit a revised submission in view of the instructor feedback. In an example scenario wherein the input from the student is a critique of another student's response, the critique may be transmitted to the other student or possibly to a teacher or professor.

Education content server 220 may continue to receive further requests from the particular student in order to complete a particular course of study. In an example scenario, in response to the next request from the student for further content in the course of study, server 220 may retrieve and transmit a model answer or the answer of other students to the question to which the student has just completed submitting a response. This allows the student to learn from having answered the question herself as well as from reviewing the model answer and/or answers from other students. In variation of this scenario, server 220, upon receiving a further request, may retrieve and transmit to the student direction to review multiple responses to the question to which the student has given a response. Server 220 may further require that the student input another response to the question after having reviewed the model response and/or responses of other students. This further response may be made available to other students and the instructor according to the process described above. In yet a further variation, the student may be presented with critiques or feedback regarding their response to a question and thereafter be required to submit a new response. In another example scenario, in response to receiving an input from the student, education content server 220 may receive and process requests for testing materials.

Further requests may be received for additional lecture materials, requests for input, previously recorded responses to input, etc. The requests may be received in any order so as to achieve the desired progress through a designed curriculum or course of study.

Response Driven Asynchronous Education

The disclosed education content service may present education content based, at least in part, on a student's responses to questions posed during the course curriculum. Sequence data may be used to define the sequence for presenting education content and corresponding requests for student input. Often the sequence of presentation of content and requests for student input is linear, and the linear sequence applies to all students. However, in other instances, the presentation of education content is not linear, but rather, depends, at least in part, on a student's prior review of education content and responses to requests for input. For example, after presenting education content to a student and receiving the student's response to a request for response, the system may evaluate the student's response. Depending upon the evaluation of the response, the student may be selectively presented with different content than a student that responded differently. For example, if the system determines that the student's response is correct, the system refers to sequence data in order to identify a next item of education content that should be presented under the particular circumstances wherein content has been presented to the student and the student has correctly responded to a particular question. If the student responded correctly, he or she may be ready to proceed with education content that addresses a new issue. However, where the student responded incorrectly, he or she might benefit from additional educational content regarding a particular point that the instructor is attempting to communicate. In an alternative scenario, the system may have presented a request for student input that may be responded to with any number of acceptable inputs. For example, the system may have requested that the student select one of several different alternatives, any one of which is acceptable but which results in a different path or branch through a course of study. For example, in an example scenario wherein the course of study relates to American history, the system may request that the student select from a list of historical figures (e.g., Thomas Paine, Benjamin Franklin, John Adams, and Patrick Henry). In response to the student's selection, the system queries its sequence database to identify content corresponding to the particular historical figure that was selected. In scenarios wherein the sequence data allows a user to select one of several alternatives, the sequence data may further specify that a student is obligated to subsequently select the other items in the list as part of the course of study. For example, in the scenario wherein the student must select from a list of historical figures, at the conclusion of the content for a first selected historical figure, the student again may be required to select one of the remaining historical figures and proceed through the corresponding education content for that particular figure.

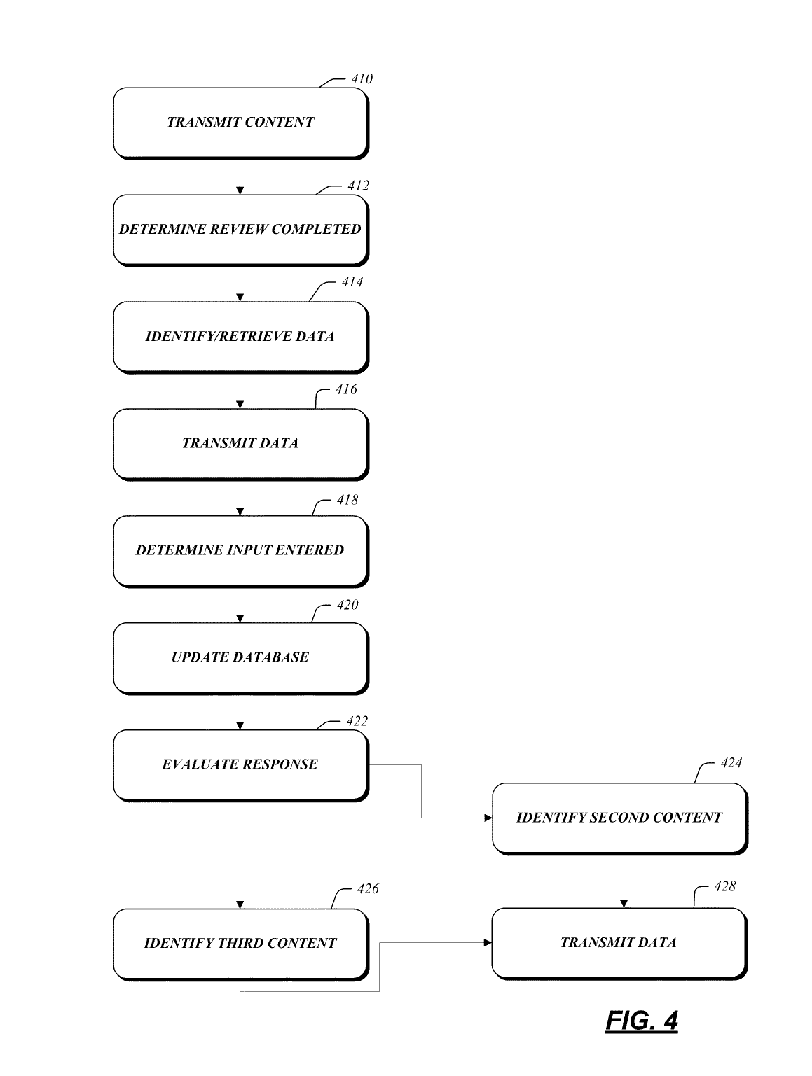

FIG. 4 provides a flow diagram of example processing for response driven presentation of education content. As shown, at block 410, education content server 220 transmits first education content to a first student via network 150. In the scenario wherein the education content is a recorded portion of a lecture, the portion of the recorded lecture is transmitted. Education content server 220 updates student data database 214 to reflect that the data was communicated to the particular student. For example, student data database 214 may be updated so that a relationship is established between data identifying the student and the data identifying the particular education content that was transmitted. The transmitted data is received at any one of devices 110 operated by the student.

At block 412, education content server 220 may determine that the student has completed reviewing the transmitted content. For example, education content server 220 may receive an automated response via network 150 when the student completes reviewing the previously transmitted content. In an alternative scenario, education content server 220 may receive a request via network 150 from the student for the next content designated in the course of study. The request may be for a specific item or may specify only that the next item in the curriculum be provided to the student. Education content server 220 updates student data database 214 to record that the particular student has reviewed the previously transmitted content item. At block 414, education content server 220 identifies and retrieves particular content to be provided to the student. The process may involve querying sequence data 212 and student data 214. For example, in an example scenario, education content server 220 may query student data 214 in order to determine which program the particular student is undertaking and the segment of information that was most recently reviewed by the particular student. Education content server 220 may then query sequence data 212 in order to identify the appropriate segment to be provided to the student given the current progress of the student in the course of study. The identified content is then retrieved from education content database 210. In an example scenario, the content retrieved from the data store is a recorded request for student input or response. The retrieved content may be any suitable for use in an education setting and may take any suitable format including text, audio, and/or video. In an example scenario, the retrieved education content may be, for example, a video recording of a question presented by a teacher or professor.

At block 416, education content server 220 transmits the retrieved request for input to the student via network 150. In the scenario wherein the retrieved request for input is a video of a recording of a question, the video is transmitted. Education content server 220 updates the student data database 214 to reflect that the data was communicated to the particular student. For example, student data database 214 may be updated so that a relationship is established between data identifying the student and the data identifying the particular content that was transmitted. The transmitted data is received at any one of devices 110 operated by the student.

At block 418, education content server 220 may determine that the student has input a response to the request for input transmitted at step 332. In an example scenario, education content server 220 may be monitoring for student input and receives an input such as, for example, a text input response, an input selection from a provided set of responses, and/or a video recording of a response from the student to the question that was presented in the previously transmitted request for input.

At block 420, upon receipt of a response from the student, education content server 220 updates student data database 214 to reflect that the student has made his/her submission and stores the actual submission. The submission may be any type of data responsive to the request for input that was previously transmitted. For example, the received input may be a video recorded response, an audio recording of a response, a document containing a typed response, or a selection from a system provided list of possible responses. Education content server 220 updates student data database 214 to record that the particular student submission and to establish a relationship between the student and the submission.

At block 422, education content server 220 evaluates the response from the student. The evaluation may involve any analysis of the response so as to determine the next data items that should be presented to the student. The evaluation may involve identifying which of several different branches of learning content is appropriate to forward to the student given the student's input. In an example scenario, the processing at block 422 may involve determining whether the response indicates that the student has grasped a particular teaching point. This may involve, for example, determining whether or not the student's response is correct or incorrect. In an example scenario, the student's response is compared to a known correct response or value that may be stored, for example, in education content 210. In another example scenario, wherein the response comprises typed text, the text might be parsed and the parsed text processed to determine whether key words, which might be stored in education content database 210, are mentioned in the response. In another example embodiment, the processing may involve determining which of several different acceptable inputs was made by the student. For example, education content server 220 may have previously requested that the student select one of several different alternatives, any one of which is acceptable, but each of which results in a different path or branch through a course of study. For example, in a scenario wherein the course of study relates to American history, education content server 220 may have previously requested that the student select from a list of historical figures (e.g., Thomas Paine, Benjamin Franklin, John Adams, and Patrick Henry). In such a scenario, at step 422, education content server 220 identifies which of the several historical figures the student has selected.

At block 424, education content server 220 identifies the appropriate content given its prior evaluation of the user's response. In an example scenario wherein education content server 220 had evaluated the student's response for being either acceptable or unacceptable, and had determined the student's response to be acceptable, education content server 220 identifies a second education content for presentation. An indication that the student's response was acceptable or correct may be interpreted as an indication that the student has understood a particular point that the instructor was attempting to teach in the recently reviewed segment. Accordingly, the student may move forward in the course of study. Education content server 220 may query sequence data 212 in order to determine the content that should be provided to the student. For example, education content server 220 may query sequence database 212 and student database 214 in order to determine the next education content item that should be provided to the student based upon the student's progress in the course of study. More particularly, education content server 220 queries sequence data 212 to identify education content that may be presented after previously presenting the first education recording, presenting the recorded request for student response, and receiving a correct response to the recorded request for student response. In an example embodiment, sequence database 212 has data stored therein that identifies content that may be presented to a student under various different circumstances. More particular, sequence database 212 has stored therein data specifying what content and requests for student input may be presented after particular content has been presented and correct student responses have been given to recorded requests for student input.

In an example scenario wherein at block 422 education content server 220 had determined which of several different acceptable inputs had been made by the student, at block 424, education content server 220 identifies the content corresponding to the particular student input. Returning again to the example wherein the student selected one of several different historical figures from a list provided by the system, and wherein at block 422 education content server 220 had identified the particular selected historical figure, at block 424, education content server identifies the content corresponding to the selection. For example, where the student had selected to review materials on Thomas Paine, at block 424, education content server 220 identifies the content corresponding to Thomas Paine. Education content server 220 may query sequence data 212 in order to determine the content that should be provided to the student. For example, education content server 220 may query sequence database 212 and student database 214 in order to determine the appropriate content item that should be provided to the student given her progress in the course of study and her selection of the particular historical figure. In an example embodiment, sequence database 212 has data stored therein that identifies content that may be presented to a student under various different circumstances including the circumstance wherein the student has selected to review materials about the particular historical figure selected by the student. [0068] In an example scenario, education content server 220 may determine from querying sequence database 212 that more than one content items may be available for access by the student under the particular circumstances. For example, according to the prescribed course of study, once a student has viewed an initial lecture portion and confirmed through his or her response to a question that they understand the initial lecture, there may be several equally important lecture content items regarding related issues that may be presented. Similarly, in the scenario wherein the student has selected to review materials regarding a particular historical figure, there may be several content items regarding the selected historical figure that may initially be presented to the student. In such instances, education content server 220 may communicate information identifying the several content items to the student and receive a selection from the student identifying the particular content item that the student is interested in viewing next.

At block 426, education content server 220 identifies the appropriate content given its prior evaluation of the user's response. In an example scenario wherein education content server 220 had evaluated the student's response for being either acceptable or unacceptable, and had determined the student's response is not acceptable, education content server 220 identifies a third education content for presentation that is different than the second education content. An indication that the student's response was not acceptable, i.e. incorrect, may be interpreted as an indication that the student has not understood a particular point that the instructor was attempting to teach. Accordingly, the student may need to receive further content on the point before moving forward in the course of study. Education content server 220 may query sequence data 212 in order to determine the content that should be provided to the student. For example, education content server 220 may query sequence database 212 and student database 214 in order to determine the next education content item that should be provided to the student based upon the student's progress in the course of study. More particularly, education content server 220 queries sequence data 212 to identify education content that may be presented after previously presenting the first education recording, presenting the recorded request for student response, and receiving an incorrect response to the recorded request for student response. In an example embodiment, sequence database 212 has data stored therein that identifies content that may be presented to a student under various different circumstances. More particular, sequence database 212 has stored therein data specifying what content and requests for student input may be presented after particular content has been presented and incorrect student responses have been given to recorded requests for student input.

In an example scenario wherein at block 422 education content server 220 had determined which of several different acceptable inputs had been made by the student, at block 426, education content server 220 identifies the content corresponding to the particular student input. Returning again to the example wherein the student selected one of several different historical figures from a list provided by the system, and wherein at block 422 education content server 220 had identified the particular selected historical figure, at block 426, education content server identifies the content corresponding to the selection. For example, where the student had selected to review materials on Benjamin Franklin, at block 424, education content server 220 identifies the content corresponding to Benjamin Franklin. Education content server 220 may query sequence data 212 in order to determine the content that should be provided to the student. For example, education content server 220 may query sequence database 212 and student database 214 in order to determine the appropriate content item that should be provided to the student given her progress in the course of study and her selection of the particular historical figure. In an example embodiment, sequence database 212 has data stored therein that identifies content that may be presented to a student under various different circumstances including the circumstance wherein the student has selected to review materials about the particular historical figure selected by the student.

In an example scenario, education content server 220 may determine from querying sequence database 212 that more than one content item may be available for access by the student under the particular circumstances. For example, according to the prescribed course of study, once a student has viewed an initial lecture portion and there is an indication through his or her response to a question that the student does not understand the initial lecture, there may be several equally important lecture content items regarding related issues that may be presented. In this instance, education content server 220 may communicate information identifying the several content items to the student and receive a selection from the student identifying the particular content item that the student is interested in viewing next.

At block 428, education content server 220 transmits the education content item that has been identified at one of blocks 424 and 426 to the student via network 150. Education content server 220 updates student data database 214 to reflect that the data was communicated to the particular student. The transmitted data is received at any one of devices 110 operated by the student.

Accordingly, applicants have disclosed systems and methods for presenting education content based, at least in part, on a student's responses to questions posed during the course curriculum. The presentation of education content is not entirely linear, but rather, depends, at least in part, on a student's prior review of education content and responses to requests for input.

Automated Evaluation of Education Content

According to another aspect of the disclosed embodiments, the education content service provides automated processes for evaluating teaching content. For example, the service may facilitate determining whether students are having difficulty understanding a particular concept or teaching point. The service automatically evaluates responses provided by students to questions posed during their course of study. For example, after recording a student's response to a particular request for student response, the service may evaluate whether or not the student's response is acceptable. In an example scenario, the question posed may have only one correct answer, and all responses from students may be evaluated relative to the answer. The system aggregates the number of incorrect responses and once the aggregate exceeds a threshold, the system notifies an appropriate person such as the course instructor. The course instructor may then consider what remedial action should be taken to address the students' less than optimal responses to the particular question. For example, the instructor may review the question herself to determine whether the format is confusing. Alternatively, the instructor may consider whether the teaching materials and/or teaching process are in need of improvement.

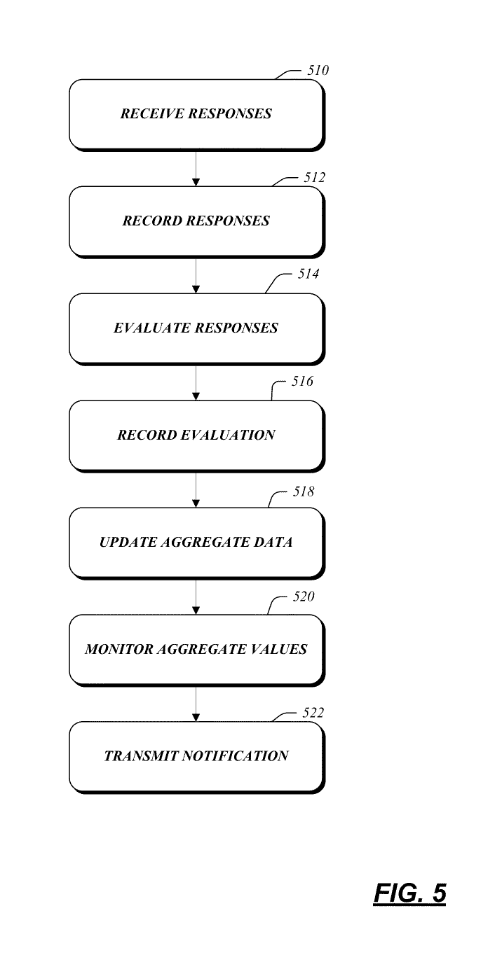

FIG. 5 provides a flow diagram of an example process for automated evaluation of education content. At block 510, education content server 220 receives responses to a particular question from a plurality of students. For example, education content server 220 may receive responses from the students who are registered for a particular course and who are required to answer particular questions. In an example scenario, server 220 may collect responses for an extended period of time. For example in an example scenario, server 220 may collect responses during the entire time that a particular course of study is active. In another example scenario, responses to the same question may be recorded and analyzed for different sessions of the same course. For example, responses to a question posed during the course of a class offered during the spring semester may be aggregated and processed as described herein together with responses to that same question when posed during the course fall semester. Similarly, if a question was posed during two different courses of study, the responses may nevertheless be processed as described herein.

At block 512, education content server 220 records the received responses in data store 214. In an example embodiment, education content server 220 stores the received responses in database 214. Data that may be used to locate and retrieve the responses is likewise stored. For example, along with the response, database 214 may also comprise data specifying the particular student that gave the response, the particular question corresponding to the question, the particular course corresponding to the question, the time of the response, etc.

At block 514, administrative server 222 evaluates the received responses and identifies each response as either acceptable or unacceptable. In an example embodiment, education content server 210 may have stored therein a model answer. The model answer may be a value that has only one correct response. In an alternative scenario, the model answer may comprise parameters that identify characteristics of acceptable answers. Administrative server 222 may compare each of the received responses to the model answer and identify whether or not the recorded response is acceptable.

At block 516, administrative server 222 records in database 214 an indication for each received response whether or not server 222 has determined the response to be acceptable or unacceptable. Data that may be used to locate and retrieve the stored data is likewise stored.

At block 518, administrative server 222 updates an aggregate value corresponding to received student responses that have been identified as unacceptable. In an example scenario, administrative server 222 may also update an aggregate value corresponding to received student responses that have been identified as acceptable. In an example embodiment, administrative server 222 may update any such aggregate values each instance that a response is evaluated. Administrative server 222 may maintain the aggregate values in memory such as, for example, in education content database 210.

At block 520, administrative server 222 monitors the values for the aggregate values and compares those values to threshold values. For example, administrative server 222 may have defined therein a threshold denoting a maximum percentage of incorrect responses that may be tolerated. In such a scenario, administrative server 222 uses the aggregate values to calculate percentage values for the acceptable and unacceptable responses and compares those values to one or more threshold values. If a threshold for unacceptable responses is met or exceeded, at block 522, administrative server 222 prepares and transmits a notification identifying the particular question or request for student response. The notification may be an email or any other type of electronic communication and may be directed to one or more individuals. In an example scenario, the notification is communicated to the instructor responsible for the course of study in which the particular question is used. The notification may comprise any information that is suitable. For example, the notification may identify the particular request for response or question that has generated the responses. The notification may further identify the percentage of answers or responses that have been determined to be unacceptable. Still further, the notification may provide suggested actions that the instructor might consider. For example, the notification may suggest that the question may be confusing students and should be review for clarity. The notification may suggest that the instructor review the course materials and the manner that the materials are presented.

The thresholds that are established in the system and which cause the system to generate notifications may be used to identify desired response episodes. For example, a threshold may be established for a target level of responses that are acceptable. In an example scenario, an instructor may modify the form of a question or change the instruction content or format and wish to be notified when student responses indicate the changes have been successful as indicated by a threshold percentage of responses being acceptable.

Selective Distribution of Instructor Feedback

According another aspect of the disclosed embodiments, the education content service allows for an instructor or professor to control the distribution of any feedback that the instructor provides. For example, an instructor or professor may review a student's response to a particular question and provide feedback regarding the student response. The instructor may also specify who may access the instructor's feedback. For example, the instructor may specify that only the student who prepared the response may access the feedback. In another example scenario, the instructor or professor may specify that the student and the teaching assistant may access the feedback. In still another scenario, the instructor or professor may specify that all students in the class may access the instructor's feedback.

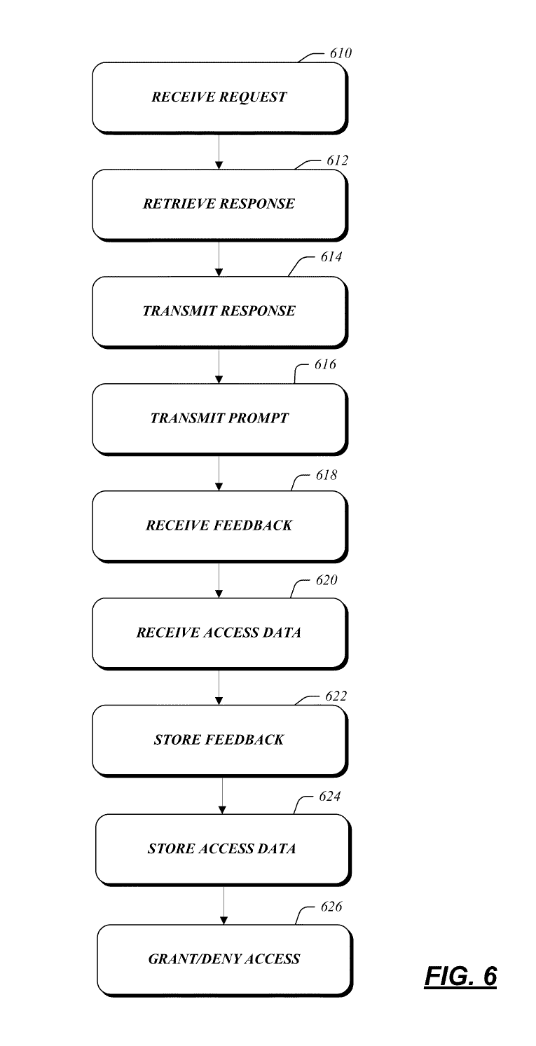

FIG. 6 provides a flow diagram of an example process whereby an instructor or teacher may use the system to control access to feedback provided by the instructor. At block 610, administrative server 222 receives a request from an instructor via network 150 to review a student's response. The request may have originated from any of devices 110. The request may include any information that is necessary to retrieve a student response for review. In an example scenario, the request may include information identifying the person making the request, the particular student whose response the requestor wishes to review, and the particular response. In an example embodiment, the request may not designate a specific response but may designate a particular class and, perhaps, a particular assignment. In one possible scenario, at block 610, administrative server 222 may receive a request to retrieve multiple responses to a particular question.

At block 612, and in response to the request, administrative server 222 queries the data store (210-214) as needed to retrieve the requested response or responses. In an example scenario, administrative server 222 may query student data 214 in order to identify and retrieve a particular response for review by the instructor. In another example scenario where the request may have specified a student and/or a class, administrative server 222 may need to query education content 210 and sequence data 212, in addition to student data 214, in order to identify the requested student response. The student responses may be any data corresponding to a student input. For example, the student response may be data corresponding to a video recording, text prepared by the student, a selection from a menu of options, or any other type of response.

At block 614, administrative server 222 transmits the retrieved student response or responses to the instructor for review. For example, administrative server 222 may communicate the response or responses via network 150 to any of devices 110 from which the request may have originated.

At block 616, administrative server 222 transmits a prompt to provide feedback regarding the student response or responses. For example administrative server 222 may transmit a user interface prompt that informs the instructor or professor that he or she may provide feedback and the manner by which to provide the feedback. For example, the prompt may inform the instructor that he or she may record a video or voice recording providing feedback regarding each student response. The prompt may provide an area for the instructor to provide textual feedback.

The prompt may further provide a mechanism by which the instructor may designate accessibility of any feedback. For example, the prompt may include a mechanism such as, for example, toggle buttons that allow the instructor to specify who may access the feedback. The mechanism may allow the instructor to designate that the feedback is private and may only be accessed by student who authored the response. The mechanism may also allow the instructor to designate that the feedback is to be available to a wider range of individuals. For example, the prompt may allow the instructor to designate that the feedback as public and accessible by all students in a class. The prompt may further provide a mechanism for the instructor to designate a group of particular individuals that may access the feedback.

The instructor or professor may then review each of the student responses that was provided, enter feedback, and designate who may review the feedback. In an example scenario, the instructor may review a video recording of the student's response and may enter feedback by recording a video providing the feedback on the student's response. The content of the feedback may be anything appropriate such as, for example, an indication that the response is correct or incorrect and how the response might have been improved.

The instructor may also specify the accessibility of the feedback. The instructor may use designated user interface mechanisms such as buttons and pull down menus to specify who may access the instructor's feedback. In an example scenario, the system defaults to any feedback being designated as private to the author of the recorded response. Accordingly, if the instructor does not designate an accessibility option, the feedback is designated as private. In another potential embodiment, the feedback is designated consistent with the accessibility of the student's response. For example, if the student's response is generally accessible to other members of the class, any feedback from the instructor regarding the student response, will also default to being public or generally accessible. Alternatively, if the student's response is only accessible to the instructor and not members of the class, the instructor's feedback will default to being accessible only by the student author.

At block 618, administrative server 222 receives input providing the instructor's feedback regarding a particular student response. The administrative server 222 may receive the feedback via network 150. The feedback may be received in any format that is suitable. For example, administrative server 222 may receive data or files corresponding to a video input, audio input, text input, etc. Further, the input may further specify any data needed to properly associate the feedback with the appropriate student response. For example, the received data may further specify the instructor, the student, and the particular student response to which the feedback corresponds.

At block 620, administrative server 222 receives input specifying the accessibility of the feedback. The input may be received in any format that is suitable. The feedback data may specify any data needed to properly associate the accessibility limitations with the appropriate student response. For example, the received data may further specify the instructor who provided the feedback, the student, and the particular student response to which the accessibility limits apply. Still further, the accessibility limitations may specify the individuals or groups of individuals who may access the feedback.

It will be appreciated that while in FIG. 6, blocks 618 and 620 are described as separate operations, the processing associated with blocks 618 and 620 may be performed simultaneously.

At block 622, administrative server 222 stores the instructor feedback. In an example embodiment, administrative server 222 stores the instructor feedback in database 214. Data needed to locate and retrieve the feedback is likewise stored. For example, the stored data may specify that the feedback is related to a particular student response.

At block 624, administrative server 224 stores data recording the accessibility limitations that have been identified for the particular feedback. In an example embodiment, administrative server 222 stores data corresponding to the accessibility limitations in database 214. For example, the data may specify that only the student author may access the feedback. In another scenario, the data may specify that all students in a particular class may access the feedback. Still further, the data may specify that a particular group of individuals may access the feedback. For example, the data may specify that the student author and a teaching assistant may access the feedback. Data required to locate and retrieve the accessibility limitations is likewise stored. For example, the stored data may specify that the

It will be appreciated that while in FIG. 6, blocks 622 and 624 are described as separate operations, the processing associated with blocks 622 and 624 may be performed simultaneously.

With the data regarding feedback and accessibility to the feedback stored in the system, when students and other users of the system subsequently access the system, at block 626, the students are granted and/or denied access to the feedback provided by the instructor based upon the accessibility data stored in connection with the student's response. Accordingly, when students other than the author of the response access the system and access the particular response, the system accesses database 214 to determine whether the particular student may also access the feedback provided by the instructor.

Student Recommendation on Student Response

According yet another aspect of the disclosed embodiments, the education content service allows students to provide recommendation feedback regarding responses prepared by other students. For example, a student who has requested and reviewed another student's response to a question may recommend the particular response. In an example scenario, the recommendation may comprise a ranking of the response relative to other responses. In another scenario, the student may enter a vote for the particular response. The vote may be an indication that the student believes the response to be the best response. When the recommendation information is received, it is stored in a database. The service maintains aggregate recommendation information and updates the information as new recommendation information received. For example, an aggregate value may be maintained identifying the number of recommendations that have been received for a particular response. In another scenario, an aggregate may record the total number of students that have voted for a particular response as being the best. Students may subsequently use the recommendation to assist in determining which responses to review.

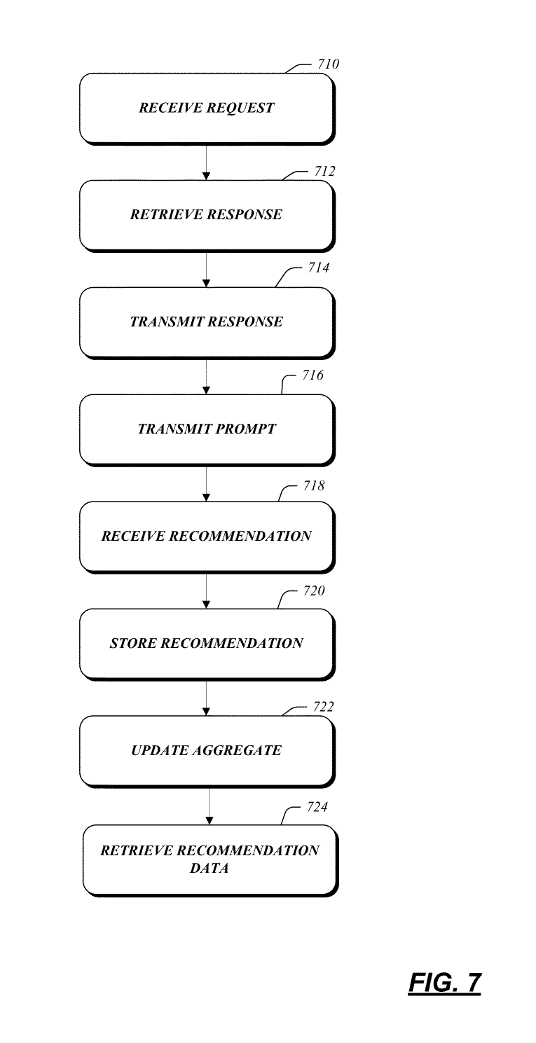

FIG. 7 provides a flow diagram of an example process whereby a student may use the system to provide recommendation feedback regarding another student's recorded response. At block 710, education content server 220 receives a request from a student via network 150 to review a student's response. The request may have originated from any of devices 110. In an example scenario, the request may be received from a student, although recommendations may be received from other individuals such as, for example, instructors. In an example scenario, the person entering a recommendation is a student that is registered for a class and wishes to review recorded responses that have been prepared by his or her classmates. The request may include any information that is necessary to retrieve a student response for review. In an example scenario, the request may comprise, for example, information identifying the student making the request, the particular student whose response the requestor wishes to review, and/or the particular response that the student wishes to review. In an example embodiment, the request may not designate a specific response but may designate a particular class and, perhaps, a particular assignment. In one example scenario, at block 710, education content server 220 may receive a request to retrieve multiple responses to a particular question.

At block 712, and in response to the request, education content server 220 queries the data store (210-214) as needed to retrieve the requested response or responses. In an example scenario, education content server 220 may query student data 214 in order to identify and retrieve a particular response for review by the student. In another example scenario, the request may have specified a student and/or a class, and education content server 220 may need to query education content 210 and sequence data 212, in addition to student data 214, in order to identify the requested student response. The student responses may be any data corresponding to a student input. For example, the student response may be data corresponding to a video recording, text prepared by the student, a selection from a menu of options, or any other type of response.

At block 714, education content server 220 transmits the retrieved student response or responses to the student for review. For example, education content server 220 may communicate the response or responses via network 150 to any of devices 110 from which the request may have originated.

At block 716, education content server 220 transmits a prompt to provide recommendation feedback regarding the student response or responses. For example education content server 220 may transmit a user interface prompt that informs the student that he or she may provide recommendation feedback and the manner by which to provide the recommendation feedback. For example, the prompt may inform the student that he or she may indicate that he or she recommends the particular student response. The recommendation may comprise a ranking of the particular student response relative to other student responses. In another embodiment, the recommendation may comprise an input indicating the student reviewing the recorded response has voted for the particular response. For example, the vote may indicate that the student found the particular response to be the best relative to others. The prompt may include user interface features that facilitate entry of recommendations. For example, push buttons corresponding to a positive or negative recommendation may be provided. Similarly, pull-down menu items may be provided that correspond to recommendations.

The student may then review the student response that was provided and enter any desired recommendation feedback. In an example scenario, the student may review a video recording of the student's response and may enter a recommendation regarding the student response. The content of the recommendation may be anything appropriate such as, for example, an indication that the response is preferred relative to other responses to the same question.

At block 718, education content server 220 receives input providing the student's recommendation regarding a particular student response. The education content server 220 may receive the recommendation via network 150. The recommendation may be received in any format that is suitable. For example, education content server 220 may receive data or files corresponding to a video input, audio input, text input, etc. Further, the input may further specify any data needed to properly associate the recommendation with the appropriate student response. For example, the received data may further specify the instructor, the student, and the particular student response to which the recommendation corresponds.

At block 720, education content server 220 stores the student recommendation information. In an example embodiment, education content server 220 stores the recommendation information in database 214. Data needed to locate and retrieve the feedback is likewise stored. For example, the stored data may specify that the feedback is related to a particular student response.

At block 722, education content server 220 updates data in database 214 that includes aggregate data for recommendations received for the particular recorded response. For example, education content server may update an aggregate value in database 214 to indicate that another student has recommended the particular student response. In another example scenario where the received recommendation involves a vote, an aggregate value recording votes is updated to reflect the new vote.

When data regarding the student's recommendation has been stored in the system, other students and other users of the system who subsequently access the system will be able to use the recommendation in connection with reviewing responses. For example, students that may be in the same class may be required to review responses prepared by other students. At block 724, previously entered recommendation data is retrieved, so that students may refer to the recommendation data entered by other students in deciding which responses to review. In an example scenario, where the recommendation data indicates there are several highly recommended recorded responses, the student is mostly likely to review the corresponding responses.

Example Computing Environment

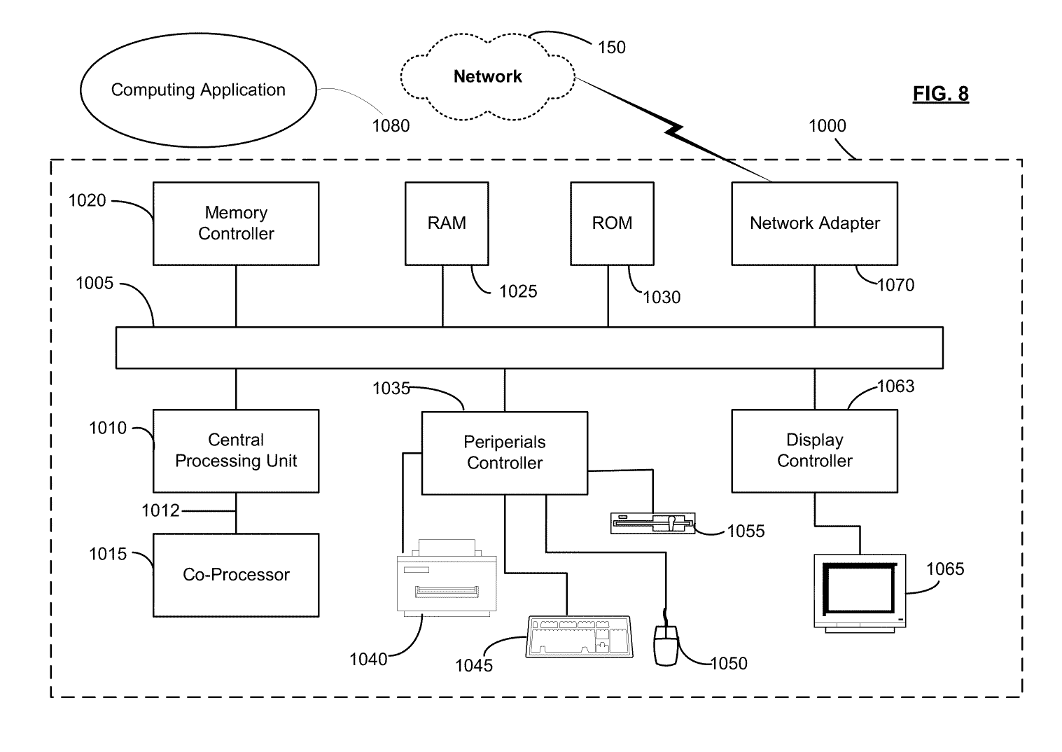

FIG. 8 depicts a block diagram of an exemplary computing system 1000 that may be used to implement the systems and methods described herein. For example, the computing system 1000 may be used to implement the education content service 120 as well as any of devices 140, 110a-e and 112a-c. The computing system 1000 may be controlled primarily by computer readable instructions that may be in the form of software. The computer readable instructions may include instructions for the computing system 1000 for storing and accessing computer readable instructions themselves. Such software may be executed within a central processing unit (CPU) 1010 to cause the computing system 1000 to perform the processes or functions associated therewith. In many known computer servers, workstations, personal computers, or the like, the CPU 1010 may be implemented by micro-electronic chips CPUs called microprocessors.

In operation, the CPU 1010 may fetch, decode, and/or execute instructions and may transfer information to and from other resources via a main data-transfer path or a system bus 1005. Such a system bus may connect the components in the computing system 1000 and may define the medium for data exchange. The computing system 1000 may further include memory devices coupled to the system bus 1005. According to an example embodiment, the memory devices may include a random access memory (RAM) 1025 and read only memory (ROM) 1030. The RAM 1025 and ROM 1030 may include circuitry that allows information to be stored and retrieved. In one embodiment, the ROM 1030 may include stored data that cannot be modified. Additionally, data stored in the RAM 1025 typically may be read or changed by CPU 1010 or other hardware devices. Access to the RAM 1025 and/or ROM 1030 may be controlled by a memory controller 1020. The memory controller 1020 may provide an address translation function that translates virtual addresses into physical addresses as instructions are executed.

In addition, the computing system 1000 may include a peripherals controller 1035 that may be responsible for communicating instructions from the CPU 1010 to peripherals, such as, a printer 1040, a keyboard 1045, a mouse 1050, and data a storage drive 1055. The computing system 1000 may further include a display 1065 that may be controlled by a display controller 1063. The display 1065 may be used to display visual output generated by the computing system 1000. Such visual output may include text, graphics, animated graphics, video, or the like. The display controller 1063 may include electronic components that generate a video signal that may be sent to the display 1065. Further, the computing system 1000 may include a network adaptor 1070 that may be used to connect the computing system 2000 to an external communication network such as the network 150, described above in FIG. 1.

Accordingly, applicants have disclosed exemplary embodiments of systems and methods for asynchronous education content delivery. The disclosed systems and methods replicate the interactive classroom learning experience, but allow for the experience to take place asynchronously and at the convenience of the students. Students are presented with recorded lectures, related questions, and model student responses to questions, all at the convenience of the student. Students may be required to provide input such as responses to questions in order to continue with a course of learning. Student inputs may be made available for consideration by others including teachers and other students. Additionally, students may review the responses of other students or, perhaps, model responses to the same questions that the student may have been required to consider and respond to.

It will be appreciated that while illustrative embodiments have been disclosed, the scope of potential embodiments is not limited to those explicitly set out. For example, while the system has been described with reference to particular scenarios wherein a particular sequence of lecture data, questions, and responses was described, the envisioned embodiments extend beyond a particular sequence of types of education content being delivered.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Those skilled in the art will appreciate that the disclosed embodiments may be provided as a subscription web based solution that anyone with an internet connection may log on and begin using the system. The potential embodiments may be developed and programmed in any web based technology platform. Alternatively, a potential embodiment may be implemented as a standalone application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented education method, comprising:
a computing system transmitting to a first student a first education recording;
the computing system transmitting to the first student a first recorded request for student response;
the computing system receiving from the first student a response to the first recorded request for student response;
evaluating the response to the first recorded request for student response;
upon determining the response to the first recorded request for student response is acceptable, identifying a second education recording for presentation;
upon determining the response to the first recorded request for student response is not acceptable, identifying a third education recording for presentation; and
transmitting either the second education recording or the third education recording to the first student.

2. The computer-implemented education method of claim 1, wherein determining the response to the first recorded request for student response is acceptable comprises determining the response to the first recorded request for student response is a correct response.

3. The computer-implemented education method of claim 2, wherein determining the response to the first recorded request for student response is a correct response comprises comparing the response to a stored response value.

4. The computer-implemented education method of claim 2, further comprising querying a database comprising data defining sequencing of education recordings and requests for student response for content to be presented after presentation of the first education recording, presentation of the first recorded request for student response, and receipt of a correct response to the first recorded request for student response.

5. The computer-implemented education method of claim 2, wherein identifying a second education recording comprises identifying an education recording that assumes understanding of concepts disclosed in the first education recording.

6. The computer-implemented education method of claim 1, wherein determining the response to the first recorded request for student response is not acceptable comprises determining the response to the first recorded request for student response is an incorrect response.

7. The computer-implemented education method of claim 6, wherein determining the response to the first recorded request for student response is an incorrect response comprises comparing the response to a stored response value.

8. The computer-implemented education method of claim 6, further comprising querying a database comprising data defining sequencing of education recordings and requests for student response for content to be presented after presentation of the first education recording, presentation of the first recorded request for student response, and receipt of an incorrect response to the first recorded request for student response.

10. The computer-implemented education method of claim 6, wherein identifying a third education recording comprises identifying an education recording that addresses a misunderstanding of concepts disclosed in the first education recording.

11. The computer-implemented education method of claim 1, wherein identifying a second education recording for presentation comprises:
identifying a plurality of education recordings;
transmitting information regarding the plurality of education recordings to the first student;
receiving a selection of one of the plurality of education recordings; and
identifying the selected one of the plurality of education recordings as the second education recording.

12. A computer-implemented method of evaluating teaching content, comprising:
receiving from each of a plurality of students a student response to a request for student response;
recording in a database the received student response for each of the plurality of students;
evaluating each received student response and identifying each received student response as either acceptable or unacceptable;
recording in a database for each received student response an indication of either acceptable or unacceptable;
determining an aggregate value corresponding to received student responses identified as unacceptable;
upon determining the aggregate value corresponding to received student responses identified as unacceptable exceeds a threshold, communicating a notification identifying the request for student response.

13. The computer-implemented method of claim 12, wherein receiving from each of a plurality of students a student response to a request for student response comprises receiving a student response from each of a plurality of students over an extended period of time.

14. The computer-implemented method of claim 12, wherein receiving from each of a plurality of students a student response to a request for student response comprises receiving a student response from each of a plurality of students during a period that a course is offered.

15. The computer-implemented method of claim 12, wherein receiving from each of a plurality of students a student response to a request for student response comprises receiving a student response from each of a plurality of students, the plurality of students enrolled in a plurality of classes.

16. The computer-implemented method of claim 12, wherein evaluating each received student response and identifying each received student response as either acceptable or unacceptable comprises comparing each received student response to an acknowledge acceptable response.

17. The computer-implemented method of claim 12, wherein evaluating each student response and identifying each received student response as either acceptable or unacceptable comprises determining whether each received student response is correct.

18. The computer-implemented method of claim 12, wherein communicating a notification identifying the request for student response comprises communicating a notification to an instructor.

19. The computer-implemented method of claim 18, wherein communicating a notification to an instructor comprises communicating a suggestion regarding the request for student response.

20. A computer-implemented method of providing feedback, comprising:
retrieving from a database a student response to a recorded request for student response;
transmitting for output the student response;
transmitting a prompt to provide feedback regarding the student response;
receiving feedback regarding the student response;
receiving input specifying accessibility of the feedback regarding the student response;
storing in the database the feedback regarding the student response; and
storing in the database data specifying accessibility of the feedback regarding the student response.

21. The computer-implemented method of claim 20, wherein retrieving from a database a student response to a recorded request for student response comprises retrieving a video recording of a student response.

22. The computer-implemented method of claim 20, wherein transmitting a prompt to provide feedback regarding the student response comprises transmitting a prompt to enter a video recording.

23. The computer-implemented method of claim 22, wherein receiving input specifying accessibility of the feedback regarding the student response comprises receiving a user interface selection.

24. The computer-implemented method of claim 20, wherein receiving input specifying accessibility of the feedback regarding the student response comprises receiving input specifying the feedback regarding the student response is accessible only by a student that generated the student response.

25. The computer-implemented method of claim 20, wherein receiving input specifying accessibility of the feedback regarding the student response comprises receiving input specifying the feedback regarding the student response is accessible by students in addition to a student that generated the student response.

26. The computer-implemented method of claim 20, wherein receiving input specifying accessibility of the feedback regarding the student response comprises receiving input specifying that the feedback is private.

27. A computer-implemented method of providing student recommendation, comprising:
retrieving from a database a student response prepared by a first student;
transmitting the student response to a second student;
transmitting a prompt to provide recommendation information to the second student;
receiving recommendation information regarding the student response from the second student;
storing in the database the recommendation information from the second student regarding the student response; and
updating in the database aggregate data to reflect the recommendation information from the second student.

28. The computer-implemented method of claim 27, further comprising receiving a request from the second student to review the student response prepared by the first student.

29. The computer-implemented method of claim 27, wherein transmitting a prompt to provide recommendation information comprises transmitting a prompt to indicate whether the second student recommends the recorded response to other students.

30. The computer-implemented method of claim 27, wherein transmitting a prompt to provide recommendation information comprises transmitting a prompt to indicate a ranking of the recorded response.

31. The computer-implemented method of claim 27, wherein transmitting a prompt to provide recommendation information comprises transmitting a prompt to indicate a vote for the best response.

32. The computer-implemented method of claim 27, wherein receiving recommendation information regarding the student response from the second student comprises receiving input specifying at least one of a recommendation, a ranking, a vote.

33. The computer-implemented method of claim 27, wherein updating in the database aggregate data to reflect the recommendation information from the second student comprises updating an aggregate value to indicate another student has recommended the student response.

34. The computer-implemented method of claim 27, wherein updating in the database aggregate data to reflect the recommendation information from the second student comprises updating an aggregate value to indicate another student has voted for the student response.
